(19) United States
(12) Patent Application Publication
(10) Pub. No.: US 2003/0028795 A1
(43) Pub. Date: Feb. 6, 2003

(54) Information processing apparatus, network system, information outputting method, storing medium and program

(75) Inventors: Yoshiaki Tomomatsu, Kanagawa (JP); Mitsuo Ohki, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/202,853

(22) Filed: Jul. 26, 2002

(30) Foreign Application Priority Data
Jul. 31, 2001 (JP) 232644/2001 (PAT.

(51) Int. Cl. H04L 9/32

(52) U.S. Cl. 713/193

(57) ABSTRACT

A network system capable of positively preventing information (content) having copyright from being outputted unfairly is provided. In an information processing apparatus in which a content managed at a content managing side is acquired via communication and the acquired content is printed and outputted, storing means stores information regarding the number of outputtable prints of the content. Output means effects print output of the content on the basis of the information stored in the storing means.

### BACKGROUND OF THE INVENTION

1. Field of the Invention

The present invention relates to an information processing apparatus, a network system, an information outputting method, a computer-readable storing medium for storing a program executing such a method, and such a program, for example, used in an apparatus or a system for printing and outputting information (content) of an image having copyright.

2. Related Background Art

In recent years, as internets has been progressed and high image quality of printers has been achieved, for example, the user can use his terminal device such as a personal computer to pick up an image having copyright therein via an internet thereby to print and output such an image.

However, regarding the print of the image having the copyright, charge, such as collection of copyright fee in accordance with the number of prints, is required with respect to the print. Thus, in general, the image having the copyright is encrypted, and, at the user's side for acquiring and printing such an image, exclusive application having a function capable of restoring the encrypted image is used.

However, in the above-mentioned conventional system designed so that the image having the copyright can be acquired via the internet and be printed, for example, after the user temporarily store the image data in his terminal device in a printable condition, such an image can be printed unfairly many times by directly outputting the image data to a printer.

### SUMMARY OF THE INVENTION

Thus, an object of the present invention is to eliminate the above-mentioned drawback.

Further, another object of the present invention is to provide at least one of an information processing apparatus, a network system, an information outputting method, a computer-readable storing medium for storing a program executing such a method, and such a program, which can positively prevent information (content) having copyright from being outputted unfairly.

A further object of the present invention is to provide at least one of an information processing apparatus, a network system, an information outputting method, a computer-readable storing medium for storing a program executing such a method, and such a program, which has a new function.

Under such objects, according to a first embodiment of the present invention, an information processing apparatus for acquiring an externally managed content via communication and for printing and outputting such a content comprises storing means for storing information regarding the number of outputtable prints of the content, and output means for effecting print output of the content on the basis of the information stored in the storing means.

According to a second embodiment, in the first embodiment, the storing means updates the information regarding the number of outputtable prints on the basis of the print output of the output means.

According to a third embodiment, in the first embodiment, the information regarding the number of outputtable prints includes money information corresponding to the number of prints.

According to a fourth embodiment, an information processing apparatus connected to a content managing side in a communication permitting condition and adapted to output a content acquired from the content managing side comprises demand ID producing means for producing demand ID of the content on the basis of at least either inherent discrimination ID or a unique value, first registration means for registering the demand ID obtained in the demand ID producing means, restoring means for restoring encrypted key information produced at the content managing side on the basis of the externally inputted demand ID, content ID and money information corresponding to the content, judging means for judging whether or not the demand ID obtained in the restoring means is registered in the first registration means, deletion means for deleting the demand ID registered in the first registration means on the basis of a judged result of the judging means, second registration means for registering the content ID and the money information obtained in the restoring means on the basis of the judged result of the judging means, and output means for outputting the content on the information registered in the second registration means.

According to a fifth embodiment, in the fourth embodiment, the output means outputs a content externally selected on the basis of a sample presented by the content managing side.

According to a sixth embodiment, in the fourth embodiment, the output means restores the content encrypted in the content managing side and outputs the restored content.

According to a seventh embodiment, in the fourth embodiment, the second registration means updates registration information corresponding to the content on the basis of content output from the output means.

According to an eighth embodiment, in the fourth embodiment, with respect to an apparatus or a system through which the content from the contents managing side is relayed, there is further provided inhibiting means for inhibiting any process of the content and processing means for effecting any process of the content.

According to a ninth embodiment, an information processing apparatus connected to a content output side in a communication permitting condition and adapted to manage a content to be provided to a print output side comprises Key producing means for producing encrypted Key information at the content output side on the basis of demand ID produced on the basis of at least either inherent discrimination ID or a unique value, content ID and money information corresponding to the content, and providing means for providing the encrypted Key information produced by the Key producing means to the content output side so that the Key information can be restored and registered at the content output side.

The other objects and features of the present invention will be apparent from the following explanation of preferred embodiments of the invention and the accompanying drawings.

### BRIEF DESCRIPTION OF THE DRAWINGS

FIG. 1 is a block diagram showing a construction of a network system to which the present invention is applied;

FIG. 2 is a flow chart for explaining an operation of the network system (operation effected when print right is purchased upon printing image data having copyright);

FIG. 3 is a flow chart for explaining an operation of a network system (operation effected when the image data having the copyright is actually printed and processed); and

FIG. 4 is a block diagram showing a construction of a computer for reading out and executing a program for causing the computer to realize a function of the network system from a computer-readable storing medium.

### DETAILED DESCRIPTION OF THE PREFERRED EMBODIMENTS

The present invention will now be fully explained in connection with embodiments thereof with reference to the accompanying drawings.

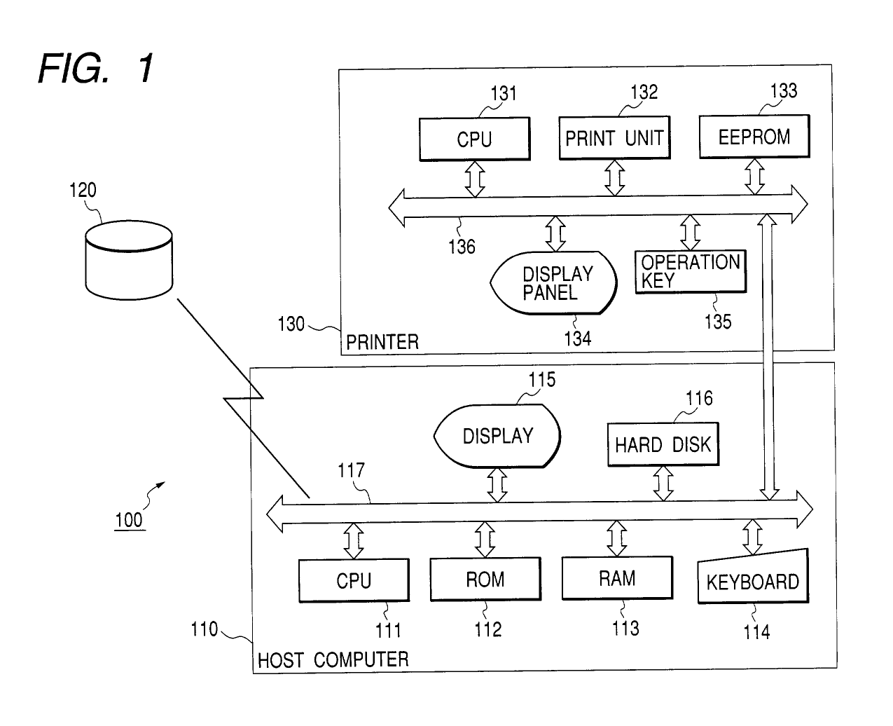

The present invention is applied to a network system 100 as shown in FIG. 1, for example.

Particularly, the network system according to the illustrated embodiment can positively prevent unfair printing of information by designing so that the printable number for each information is registered in a printer 130.

<Entire Construction of Network System 100>

As shown in FIG. 1, in the network system 100, a content center 120 and a user's side host computer 110 are interconnected via a network and the like in a communication permitting condition.

In the host computer 110, a CPU 111, a ROM 112, a RAM 113, a keyboard 114, a display 115 and a hard disk 116 are interconnected via a system bus 117.

A boot program and the like is stored in the ROM 112.

The RAM 113 is used as a main memory and a work area.

The keyboard 114 serves to cause the user to issue command for carrying out various operations to the host computer 110.

The display 115 displays a processed result and the like.

The CPU 111 controls the entire operation of the host computer, for example, by reading out and executing the processing program in the ROM 112.

The content center 120 is connected to the host computer 110 via an internet or the like and serves to manage copyright fee regarding a content, as well as to distribute the content such as an image.

In the printer 130, a CPU 131, a print unit 132, an EEPROM 133, a display panel 134 and an operation key 135 are interconnected via a bus 136, and the printer is connected to the host computer 110 via an interface.

The CPU 131 controls the entire operation of the printer 130. As such control, for example, there is control for the printing by outputting data received from the host computer 110 to the print unit 132.

The EEPROM 133 stores setting information required for the printing operation in the print unit 132 and also stores managing data when the data having copyright is printed.

The display panel 134 and the operation key 135 are used for operation for operating the printer 130 by the user and error display.

<Operation of Network System 100>

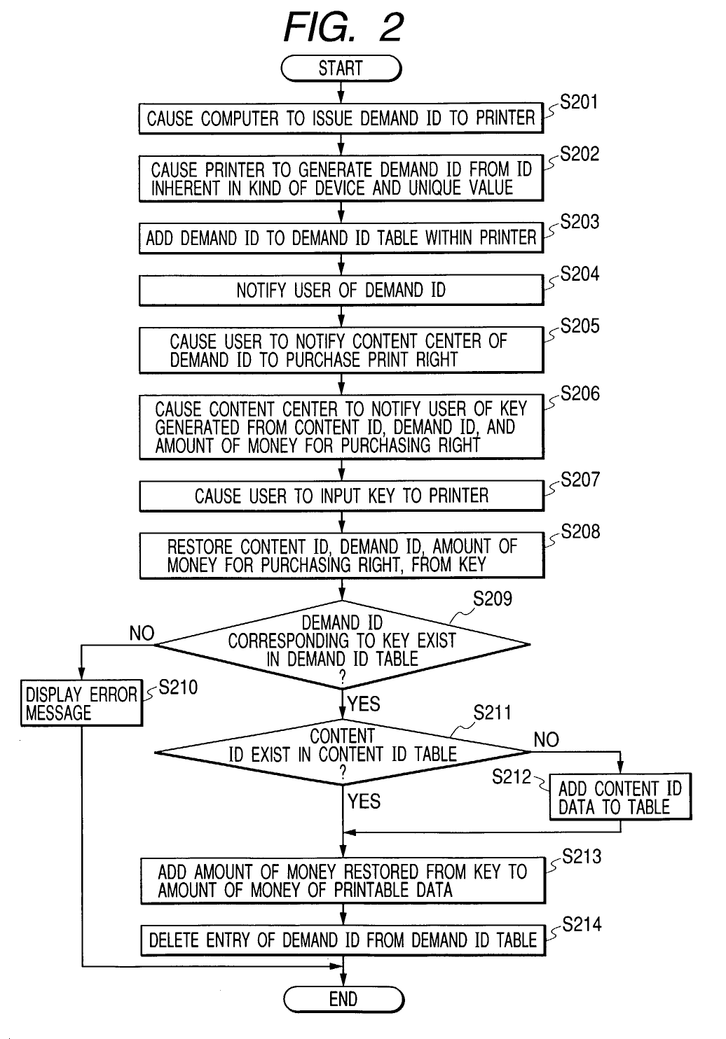

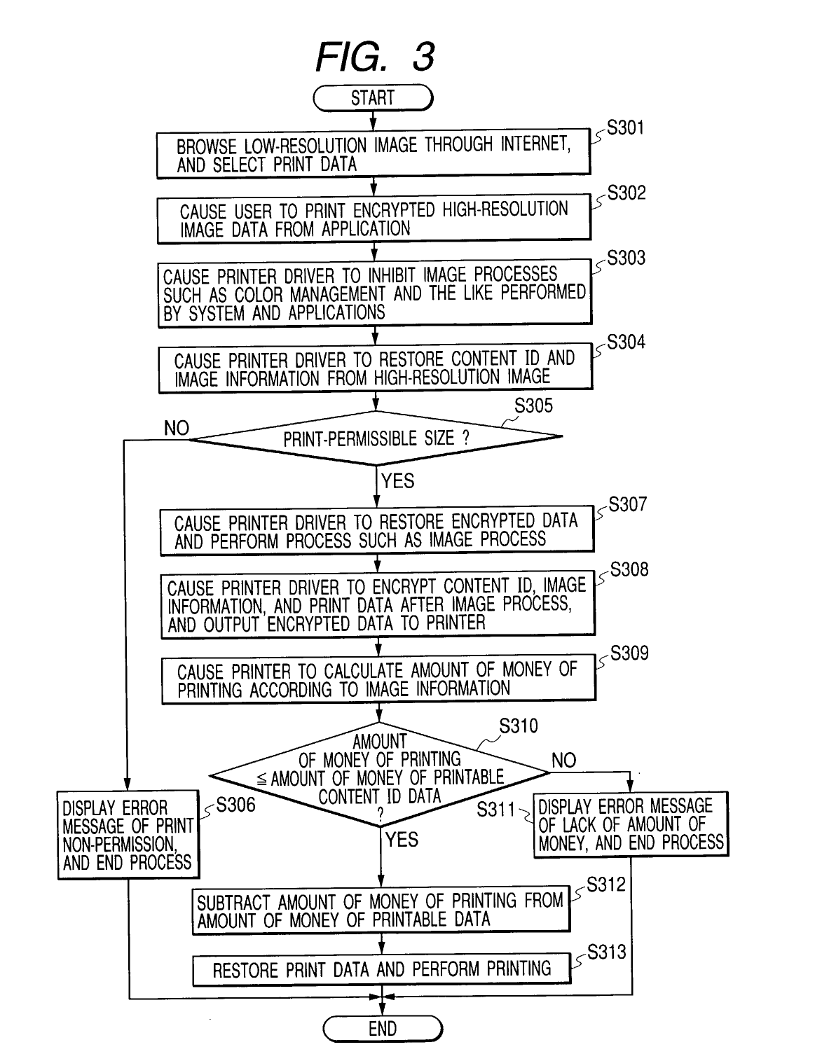

FIGS. 2 and 3 show the operation of the network system 100 as flow charts.

More specifically, FIG. 2 shows an operation (1) of the network system 100 effected when the user purchases print right upon printing image data having copyright via the host computer 110, and FIG. 3 shows an operation (2) of the network system 100 effected when the user actually prints and processes the image data having the copyright via the host computer 110. Operation (1): refer to FIG. 2

First of all, when there is information (image data, here) desired to be printed, the user most purchase print right regarding the image data (content). Although the required print right can be purchases each time, the print right can also be purchased collectively. Normally, the user's working for such purchasing is performed by bi-directional communication to the content center 120 and the printer 130 by using application operated on the host computer 110.

Step S210:

The user designates an amount of money of printing and content ID (ID of desired image data) by using the host computer 110.

As a result, in the host computer 110, the CPU 111 issues demand ID to the printer 130.

Step S202:

In the printer 130, the CPU 131 produces or generates demand ID from ID inherent in kind of a device and a unique value on the basis of the demand ID from the host computer 110.

Here, concretely explaining the demand ID, first of all, the user purchases right for the demand ID as “Key” which will be described later. Particularly, since the demand ID is reserved within the printer 130 until the Key is inputted and deleted simultaneously with registration of the Key, plural registrations due to the same Key in the same printer and unfair printing due to registration in plural printers can positively be prevented.

Step S203:

The CPU 131 manages so that the same demand ID is not generated again by registering (holding) the demand ID generated in the step S202 in a demand ID table of the EEPROM 133. The EEPROM 133 can continue to hold the registered information even when a power supply of the printer 130 is turned OFF.

Step S204:

The CPU 131 informs the user of the demand ID generated in the step S202 via the host computer 110.

Step S205:

In the host computer 110, the CPU 111 receives the demand ID informed from the printer 130, by bi-directional communication effected by application operating on the host computer 110.

The CPU 111 informs or notifies the content center (managing the designated content) of the demand ID and executes purchasing process of print right regarding an amount of money for purchasing by using electronic settlement.

Step S206:

The content center 120 produces or generates encrypted Key on the basis of the demand ID from the host computer 110, the content ID designated by the user in the step S201 and the amount of money of purchasing and informs the host computer 110 of the encrypted Key.

Steps S206 and S207:

In the host computer 110, the CPU 111 receives the encrypted Key from the content center 120 and informs the user of the encrypted Key (step S206). As a result, the user inputs the encrypted Key to the printer 130 via the host computer 110 (step S207).

Step S208:

In the printer 130, the CPU 131 firstly restores the content ID, demand ID and amount of money of purchasing from the encrypted Key in order to register the content ID and amount of money of purchasing obtained from the encrypted Key inputted by the user in the EEPROM 133.

Step S209:

The CPU 131 judges whether or not the demand ID obtained in the step S208 is registered in the demand ID table of the EEPROM 133.

As a result of such judgement, if registered, the program goes to a step S211; whereas, if not registered, the program goes to a step S210.

Step S210:

As a result of the judgement in the step S209, if the demand ID is not registered in the demand ID table of the EEPROM 133, the CPU 131 regards the demand ID so that generated by another printer or that has already been used and notifies the host computer of that fact.

In the host computer 110, the CPU 111 displays error information on the display 115 on the basis of such notification from the printer 130.

Thereafter, the process is ended.

Steps S211 and S212:

As a result of the judgement in the step S209, if the demand ID is registered in the demand ID table of the EEPROM 133, the CPU 131 regards the demand ID as the correct demand ID generated by its printer 130 and registers the print right for the user in the EEPROM 133 for every content ID (content designated by the user) obtained in the step S208.

More specifically, first of all, a content ID table of the EEPROM 133 reserves the content ID and an amount of money of printable data designated by the user as a pair.

Thus, first of all, the CPU 131 judges whether or not the content ID obtained in the step S208 is already registered in the content ID table of the EEPROM 133 (step S211). As a result of such judgement, if not registered in the content ID table of the EEPROM 133, entry for the content ID is newly added to the content ID table of the EEPROM 133 (step S212).

Step S213:

The CPU 131 adds the amount of money of printable data obtained in the step S208 to the amount of money of printable data of entry for the content ID of the EEPROM 133.

Step S214:

Since the registration process regarding the Key purchased by the user is ended at the time point when the process of the step S213 is finished, the CPU 131 deletes the demand ID registered in the demand ID table of the EEPROM 133. As a result, that demand ID cannot be used again.

Thereafter, the process is ended.

Incidentally, in the above-mentioned operation, regarding the request of the demand ID and the method for obtaining the Key corresponding to the demand ID, the demand ID can be requested and the Key corresponding to the Key can be obtained by bi-directional communication to the printer 130 by using the application operating on the host computer 110 or the demand ID can be requested and the Key corresponding to the Key can be obtained by directly manipulating the operation Key 135 of the printer 130 by the user.

Further, regarding the notification of the demand ID, a method for displaying the demand ID on the display panel 134 of the printer of a method for printing the demand ID on a paper sheet may be adopted.

Further, regarding the purchasing of the Key, for example, user may directly call the demand ID and purchase the Key by telephone or on shop with respect to the content center 120 or the agent shop. Operation (2): refer to FIG. 3

Step S301:

The user effects access to the content center 120 through the network by using his host computer 110 to browse a sample image and to select a desired image to be printed.

Here, as the sample image, an image which does not arises a problem even when it is printed as it is, such as a low-resolution image or an image on which a character showing “sample” is also indicated.

The content center 120 can effect access to a high-resolution image (original image) and corresponding to the sample image. The original image is reserved in an encrypted condition so that, if it is displayed or printed as it is, the image is displayed or printed as a distorted image not to obtain a correct result; however, regarding the original image for which the print right is purchases, the original image can be restored in the printer driver or the printer to correctly display or print the image.

Incidentally, the encrypted original image can be printed not only by the host computer 110 accessing to the content center 120, but also, for example, by temporarily down-loading the original image to the hard disk 116 of the host computer 110 and by attaching it to other application.

Step S302:

The user carries not layout process or data (such as characters) adding process with respect to a desired original image (encrypted high-resolution image) obtained from the content center 120, by using the application operating on the host computer 110 and instructs print process to the printer 130.

Step S303:

Here, although the encrypted image data is subjected to restoring process in the printer 130 (and printer driver), if image process such as color process is executed by the application or OS (operating system) of the host computer 110, the restoring process may not be carried out.

Thus, in the printer 130, the CPU 131 causes the printer driver to inhibit the image process effected by the application or OS of the host computer 110.

More specifically, for example, if the application or OS of the host computer 110 is OS or application for executing color process such as color management, the printer driver declares that the color process is effected at the printer 130 side. As a result, the application or OS of the host computer 110 does not execute the color process and demands the color process to the printer side 130. That is to say, the encrypted image data before the color process is supplied to the printer 130.

Although the encrypted image data is data which can be handled by normal application, added information other than the actual image is reserved in a partial area. The added information includes content ID for specifying the content and image information such as amount of money of printing and the added information is encrypted together with the image data.

Step S304:

The CPU 131 causes the printer driver to restore the added information of the encrypted image to obtain the content ID and the image information.

Here, although the image information may merely include information regarding an amount of money of printing per one time or print, for example, since there is a case where the image is enlarged by the application and is printed, the image information may be information in which an amount of money of enlargement process is set to be higher. That is to say, the image information may be information designating an amount of money per print size. Further, the image information may be information including print-permissible size in which the print is not permitted depending upon the print size.

Step S305:

The CPU 131 judges whether or not the print size of the image to be printed (encrypted image) execution of which is instructed by the user in the step S302 is the print-permissible size indicated by the image information obtained in the step S304.

As a result of such judgement, if it is the print-permissible size, the program goes to a step S307; whereas, if otherwise, the program goes to a step S306.

Step S306:

As a result of the judgement in the step S305, if the print with a size greater than the print-permissible size is instructed, the CPU 131 displays an error message indicating such a fact on the display panel 134.

Thereafter, the process is ended.

Step S307:

As a result of the judgement in the step S305, if the print with the print permissible size is instructed from the user, the CPU 131 firstly causes the printer driver to execute rendering of vector data and color process and image process such as halftone process with respect to the restored image of the encrypted image in order to effect print process of the encrypted image in the print unit 132, for example, when the print unit 132 is a printer called as a so-called dam printer.

More specifically, the CPU 131 causes the printer driver to restore the encrypted image and to execute the color process and the image process such as the halftone process with respect to the restored image and to convert the image into data having image format which can be recognized by the print unit 132.

Step S308:

The CPU 131 causes the printer driver to re-encrypt the content ID and the image information (information regarding the amount of money of printing and print size) obtained in the step S304 and the print process image data generated in the step S307.

Incidentally, here, while an example that the print unit 132 is the dam printer was explained, the present invention is not limited to such an example, but, for example, the print unit may be a high function printer. In this case, since the print unit 132 itself executes the above-mentioned processes, the process in the step S307 is not carried out and can be realized by sending the encrypted image data to the printer 130.

Step S309:

The CPU 131 restores the content ID and the image information (information regarding the amount of money of printing and print size) among the data re-encrypted by the printer driver in the step S308 and calculates the amount of money of printing on the basis if such information.

Step S310:

The CPU 131 judges whether or not the amount of money of printing obtained in the step S309 is smaller than an amount of money of each printable content ID stored in the EEPROM 133.

As a result of such judgement, if it is judged to be smaller than the amount of money of printable data, the program goes to a step S312; whereas, if otherwise, the program goes to a step S311.

Step S311:

As a result of the judgement in the step S310, if the amount of money of printing exceeds the amount of money of printable data, the CPU 131 displays a message that the printing cannot be effected due to lack of amount of money on the display panel 134.

Thereafter, the process is ended.

Incidentally, regarding the displaying of the message, such displaying is not limited to the displaying on the display panel 134 of the printer 130, but, for example, the message may be displayed on the display 115 of the host computer 110 by bi-directional communication between the printer 130 and the host computer 110. Alternatively, the error message may be printed on a print sheet by the print unit 132 of the printer 130.

Step S312:

As a result of the judgement in the step S310, if the amount of money of printing is smaller than the amount of money of printable data, the CPU 131 subtracts the amount of money of printing from the amount of money of printable data stored in the EEPROM 133.

Step S313:

The CPU 131 restores the print image data among the data re-encrypted by the printer driver in the step S308 and prints a result in the printer unit 132.

Incidentally, in the above-mentioned operation, while an example that the access is effected, via the internet and the like, to the sample image held in the content center 120 and the encrypted high-resolution image corresponding to the sample image was explained, the present invention is not limited to such as example, but, for example, both or either of the images may be distributed by a storing medium such as a CD-ROM.

Further, it should be noted that the object of the present invention can be achieved by supplying a storing medium storing a program code of software for executing the functions of the host and the terminal according to the illustrated embodiment to the system or the apparatus and by reading out and executing the program code stored in the storing medium by means of a computer (or CPU or MPU) of the system or the apparatus.

In this case, the program code itself read out from the storing medium realizes functions of the illustrated embodiment, and, thus, the storing medium storing such program code and the program code constitute the present invention.

As the storing medium for supplying the program code, for example, a ROM, a flexible disk, a hard disk, an optical disk, a photo-magnetic disk, CD-ROM, CD-R, a magnetic tape, a non-volatile memory card or the like can be used.

Further, it should be noted that the present invention includes a concept that not only the function of the above-mentioned embodiment is realized by executing the program code read out by means of the computer, but also OS (operating system) running on the computer executes the actual process partially or totally on the basis of instruction of the program code to realize the function of the embodiment.

Further, it should be noted that the present invention includes a concept that, after the program code read out from the storing medium is written in a memory of a function expansion board inserted into the computer or a function expansion unit connected to the computer, a CPU of the function expansion board or of the function expansion unit executes the actual process partially or totally on the basis of instruction of the program code to realize the function of the embodiment.

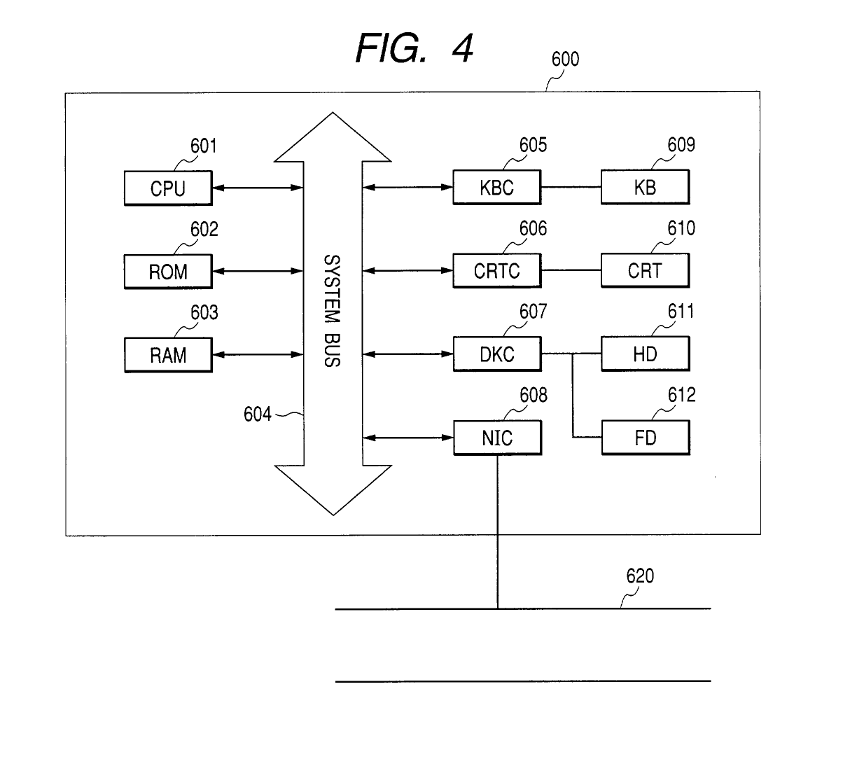

FIG. 4 shows a function 600 of the computer.

As shown in FIG. 4, in the computer function 600, a CPU 601, a ROM 602, a RAM 603, a keyboard controller (KBC) 605 of a keyboard (KB) 609, a CRT controller (CRTC) 606 of a CRT display (CRT) 610 as a display unit, a disk controller (DKC) 607 of a hard disk (HD) 611 and a flexible disk (FD) 612, and a network interface controller (NIC) 608 for connection to a network 620 are interconnected via a system bus 604 in a communication permitting condition.

The CPU 601 serves to collectively control various elements connected to the system bus 604 by executing software stored in the ROM 602 or the HD 611 or software supplied from the FD 612.

That is to say, the CPU 601 effects the control for realizing the operation in the illustrated embodiment by reading out and executing a processing program from the ROM 602, or the HD 611 or the FD 612 in accordance with a predetermined sequence.

The RAM 603 acts as a main memory or a work area.

The KBC 605 controls instruction input from the KB 609 or a pointing device (not shown).

The CRT 606 controls the displaying of the CRT 610.

The DKC 607 controls the access to the HD 611 and the FD 612 storing a boot program, various applications, an edition file, a user file, a network management program and the predetermined processing program according to the illustrated embodiment.

The NIC 608 communications the data with respect to the apparatus or the system on the network 620 in a bi-directionally.

As mentioned above, according to the preferred embodiment of the present invention, when the externally managed content (image information having copyright and the like) is acquired and outputted via the network communication, the number of outputtable prints or information regarding the amount of money is registered in the output side (printer and the like) for each content to be outputted. Further, the registered information is updated (the amount of money corresponding to the output is subtracted from the registered information regarding the amount of money, and the like) on the basis of the actual output of the content. As a result, the user can positively be prevented from printing and outputting the image unfairly many times.

What is claimed is:

1. An information processing apparatus for acquiring an externally managed content via communication and for printing and outputting such a content, comprising:
storing means for storing information regarding the number of outputtable prints of the content; and
output means for effecting print output of the content on the basis of the information stored in said storing means.

2. An information processing apparatus according to claim 1, wherein said storing means updates the information regarding the number of outputtable prints on the basis of the print output of said output means.

3. An information processing apparatus according to claim 1, wherein the information regarding the number of outputtable prints includes amount of money information corresponding to the number of prints.

4. An information processing apparatus connected to a content managing side in a communication permitting condition and adapted to output a content acquired from said content managing side, comprising:
demand ID producing means for producing demand ID of the content on the basis of at least either inherent discrimination ID or a unique value;
first registration means for registering the demand ID obtained in said demand ID producing means;
restoring means for restoring encrypted Key information produced at said content managing side on the basis of the externally inputted demand ID, content ID and amount of money information corresponding to the content;
judging means for judging whether or not the demand ID obtained in said restoring means is registered in said first registration means;
deletion means for deleting the demand ID registered in said first registration means on the basis of a judged result of said judging means;
second registration means for registering the content ID and the amount of money information obtained in said restoring means on the basis of the judged result of said judging means; and
output means for outputting the content on the basis of the information registered in said second registration means.

5. An information processing apparatus according to claim 4, wherein said output means outputs a content externally selected on the basis of a sample presented by said content managing side.

6. An information processing apparatus according to claim 4, wherein said output means restores the content encrypted in said content managing side and outputs the restored content.

7. An information processing apparatus according to claim 4, wherein said second registration means updates registration information corresponding to the content on the basis of content output form said output means.

8. An information processing apparatus according to claim 4, wherein, with respect to an apparatus or a system through which the content from said contents managing side is relayed, there is further provided inhibiting means for inhibiting any process of the content and processing means for effecting any process of the content.

9. An information processing apparatus connected to a content output side in a communication permitting condition and adapted to manage a content to be provided to a print output side, comprising:
Key producing means for producing encrypted Key information at said content output side on the basis of demand ID produced on the basis of at least either inherent discrimination ID or a unique value, content ID and amount of money information corresponding to the content; and
providing means for providing the encrypted Key information produced by said Key producing means to said content output side so that the Key information can be restored and registered at said content output side.

10. A network system including plural equipments interconnected via a network in a communication permitting condition, wherein:
at least one of said plural equipments has a function of an information processing apparatus according to claim 1.

11. An information outputting method for printing and outputting a content acquired from a content managing side via communication, comprising:
a storing step for storing information regarding the number of outputtable prints of the content at a print output side;
an outputting step for effecting print output of the content on the basis of the information stored in said storing step, at said print output side.

12. An information outputting method for outputting a content acquired from a content managing side via communication at a content output side, wherein:
processing steps executed at said output side including:
a demand ID producing step for producing demand ID of the content from at least either inherent discrimination ID or a unique value on the basis of instruction from the user;
a first informing step for informing the user of the demand ID obtained in said demand ID producing step; and
a first registering step for registering the demand ID obtained in said demand ID producing step; processing steps executed in said managing side including:
a Key producing step for producing encrypted Key information on the basis of the demand ID inputted by the user, content ID instructed from the user and amount of money information corresponding to the content; and
a second informing step for informing the user of the encrypted Key information obtained in said Key producing step;
processing steps executed at said output side further including:
a restoring step for restoring the demand ID, content ID and amount of money information from the encrypted Key information inputted by the user;
a judging step for judging whether or not the demand ID obtained in said restoring step is registered by said first registering step;
a deleting step for deleting the demand ID registered by said first registering step on the basis of a judged result in said judging step;
a second registering step for registering the content ID and amount of money information obtained in said restoring step on the basis of the judged result in said judging step; and
an outputting step for outputting the content instructed by the user on the basis of the information registered in said second registering step.

13. An information outputting method according to claim 12, wherein the processing steps executed at said managing side include a sample providing step for providing a sample of the content to said output side, and a content providing step for encrypting the content selected by the user on the basis of the sample at said output side and for providing the encrypted content; and
said outputting step among the processing steps executed at said output side includes a step for restoring the encrypted content and for outputting the restored content.

14. An information outputting method according to claim 12, wherein said second registering step among the processing steps executed at said output side includes a step for subtracting a corresponding amount of money from the amount of money information on the basis of output at said output side.

15. A computer-readable storing medium storing a program for causing a computer to realize a function of an information processing apparatus according to claim 1 or a function of a network system according to claim 10.

16. A computer-readable storing medium storing a program for causing a computer to execute the processing steps of an information outputting method according to claim 11.

17. A program for causing a computer to realize a function of an information processing apparatus according to claim 1 or a function of a network system according to claim 10.

18. A program for causing a computer to execute the processing steps of an information outputting method according to claim 11.
